(19) United States
(12) Patent Application Publication
(10) Pub. No.: US 2022/0027935 A1
(43) Pub. Date: Jan. 27, 2022

(54) BUSINESS PLATFORM FOR NETWORK MARKETING

(71) Applicants: U-Jong Lee, Suwon (KR); GEMMA KOREA, Seoul (KR)

(72) Inventor: U-Jong LEE, Suwon (KR)

(21) Appl. No.: 17/371,078

(22) Filed: Jul. 8, 2021

(30) Foreign Application Priority Data
Jul. 21, 2020 (KR) 10-2020-0090171

(51) Int. Cl. G06Q 30/02; G06Q 30/06; G06Q 20/32; H04L 29/06

(52) U.S. Cl. CPC G06Q 30/0214; G06Q 30/0206; G06Q 30/0631; G06Q 30/0201; G06Q 30/0215; H04L 65/60; G06Q 30/0226; G06Q 30/0236; G06Q 20/322; G06Q 30/0238; G06Q 30/0222

(57) ABSTRACT

Provided is a business platform for network marketing capable of being used as sales parameters of a business member and a test bed of a product by doubly operating a customer complex mall used by general members as customers and a membership mall used only by business members and distributing excellent products of the business member sold in the customer complex mall through the membership mall.

### CROSS-REFERENCE TO RELATED APPLICATION

This application claims under 35 U.S.C. § 119(a) the benefit of Korean Patent Application No. 10-2020-0090171 filed on Jul. 21, 2020, the entire contents of which are incorporated herein by reference.

### BACKGROUND

### (a) Technical Field

The present invention relates to a business platform for network marketing, and more particularly, to a business platform for network marketing capable of facilitating customer acquisition and increased sales of franchises opened in a consumer complex mall and compensating for some of sales with franchise rewards or membership PVs to members by operating doubly a consumer complex mall used by general members and business members and a membership mall used by the business members.

### (b) Background Art

Network marketing means widening gradually the sales range of products by infinitely repeating a process of converting a general member who has used any product into a business member selling the corresponding product due to his own intention by recognizing the excellence of the product and furthermore converting a general member recognizing the excellence of the product into a business member again by recommendation of a newly converted business member.

In this network marketing technique, compensation is made in accordance with sales such as new sales and repurchase achieved by the business member and sub-business members corresponding to a member family tree constructed by the business member. At this time, generally, the compensation is made by calculating a point value (PV) according to sales achieved by the business member.

In the related art, in Korean Patent Registration No. 10-1803863 (issued on Nov. 27, 2017), there is disclosed marketing system and method for combining network marketing and cloud funding.

In the related art, as illustrated in FIG. 1, there is disclosed a marketing system for combining network marketing and cloud funding which operates a double compensation system in which a lower line invests in an upper line through a cloud funding server to receive a predetermined dividend while receiving a reward through a network marketing server due to the growth of the lower line.

The marketing system for combining network marketing and cloud funding includes a network marketing server including a member information database 240 which stores member account information, a member code issuance unit 210 which issues a member code in the member account, a member code level calculation unit 220 which determines a member code level according to a level up condition based on the number of new member accounts attracted via the member code, and a member code level reward payment unit that pays a reward according to the member code level; and a cloud funding server including a member code position calculation unit 310 which re-determines a position of the member code according to the member code level for each pre-set period, a sponsoring code selling unit 320 selling a sponsoring code to the member account, and a sponsoring code division unit 330 which allocates funds created through sponsoring code sales to the member code. The sponsoring code includes a level retaining sponsoring code in which the member account needs to purchase a product regularly to maintain the level of the member code, an autonomous sponsoring code in which the member account purchase a product autonomously to donate to another member account, and a forced sponsoring code in which the member account needs to purchase a product in proportion to the number of lower lines via the member code.

The cloud funding server allocates the level retaining sponsoring code and the forced sponsoring code in descending order according to the position of the member code and allocates the autonomous sponsoring code in ascending order.

However, the marketing system had a problem in that since products to be forcibly purchased by the members are preset, newly participating members or existing members need to forcibly purchase unnecessary products to maintain their levels and accordingly, a substantial compensation cannot be made to the members.

Further, in the related art, there was a problem that since there is provided no separate means to provide tangible/intangible products or services produced or provided by the existing members to general members, sales parameters of the network marketing system are systematically limited.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the problems and other problems. An object of the present invention is to provide a business platform for network marketing which is useful for both franchises and members by operating doubly a consumer complex mall used by both general members as customers and business members and a membership mall used by the business members to allow franchises opened in a consumer complex mall to facilitate increased sales using a human network of business members and compensate for rewards and point values (PVs) of the franchises to the members.

According to an aspect of the present invention to solve the problem, there is provided a business platform for network marketing in which a customer complex mall used by general members as customers to purchase tangible/intangible products and a membership mall used by business members are doubly operated, the business platform for network marketing including: a marketing server constructed with a customer complex mall in which general members as final customers are able to purchase products and services and a membership mall in which only business members are able to purchase products; and a point server including a PV tracking management unit which calculates a predetermined point value (PV) in association with a personal code of the business member according to sales generated when the business member purchases or sells the products in the customer complex mall and the membership mall,

wherein the personal code may be configured by combining an online ID of the business member, division information of the customer complex mall and the membership mall, and address information of the product, and

the PV tracking management unit may include a personal code of an upper member recommending the business member, a personal code of a lower member recommended and registered by the business member, and a personal code association terminal in which a predetermined code level of determining a member rating is stored according to a point value (PV) of the business member.

The customer complex mall may include a member sales unit for selling products manufactured or distributed by the business member to general customers; an affiliate business unit for selling products and services of an affiliate for travel goods, car rental goods, airline tickets and offline services; and a reward sales management unit including a coupon management terminal for delivering and managing a discount coupon issued by the affiliate and the business member to general members and a reward management terminal managing a reward according to the products and the services sold to the general member, the reward sales management unit includes a reward transmission terminal which transmits a reward for the business member and a sales performance for products in which the business member is registered as a recommender to the point server, and the point server includes a complex mall performance management unit which converts and manages the reward and sales performance transmitted from the reward transmission terminal to the point value (PV).

The reward sales management unit may include a member coupon transmission terminal for batch-transmitting the discount coupon to the business member of the membership mall.

The customer complex mall may include a product price setting terminal for setting the purchase prices of products purchasable by the general member and the business member at a predetermined rate, respectively.

The customer complex mall may include a position search unit which provides a search service for the position of an offline store so as to search an offline store providing products and services in a mobile phone and purchase the products and the services.

The member sales unit may include a product recommendation terminal which transmits a product list which is calculated based on a monthly sales performance of the product so as to register and sell products with the calculated monthly sales performance and excellent preference of the general member in the membership mall.

The point server may include a family tree generation unit which generates a family tree having a binary structure by grouping a point value (PV) of the business member and point values (PVs) of a plurality of lower business members recommended by the business member into a large performance and a small performance to be divided into left and right sides; and a compensation calculation unit which calculates the code level of the business member based on the large performance and the small performance and calculates a compensation bonus of the business member according to a predetermined compensation rate based on the calculated code level.

The compensation bonus may consist of a weekly pay bonus calculated in weekly units, and a monthly pay bonus calculated in monthly units,

the weekly pay bonus may include a recommended bonus which is paid according to a weekly PV calculated depending on weekly new sales and repurchased sales of a lower member recommended by the business member who achieves the code level at a predetermined level or more and a team bonus which is paid at a predetermined rate according to the small performance generated in the family tree, and

the monthly pay bonus may include a leadership bonus which is paid according to a predetermined rate when the business member who achieves the code level at a predetermined level or more achieves the small performance at a monthly PV or more, and a leadership matching bonus which is paid according to a predetermined rate based on the small performance of only the business member who achieves the leadership bonus at a predetermined level or more and the lower member.

The family tree generation unit may include a multi-code generation terminal which generates an avatar code of the business member so that some of the point value (PV) of the business member who achieves the code level at a predetermined level or more is included in the bottom of the small performance.

The customer complex mall may include a media commerce unit including a real-time streaming promotion terminal which promotes a product provided in real time at a special discount rate in a predetermined time zone as a video and a community promotion terminal which may easily link an event homage address and thumbnails related with the product so as to promote the video of the real-time streaming promotion terminal in conjunction with the personal code in an SNS of the business member in advance; and an SNS saving terminal which saves the sales generated when the general member accesses the SNS of the business member through promotion phrases according to the personal code.

The business platform for network marketing of the present invention has the following effects.

First, the customer complex mall used by both the business member and the general member in addition to the membership mall used by the business member of the network marketing are provided to recommend more qualitative and proven products to the membership mall by using the product recommendation terminal which transmits a list of excellent products sold in the customer complex mall to the membership mall.

Second, the franchise opened in the customer complex mall makes it possible to easily secure loyal regular customers by using a human network of the business member and as the human network of superior business members spreads throughout the world, new customers continuously increase to expect increased additional sales.

Third, the tangible/intangible products sold in the consumer complex mall are sold separately from products that are directly sold according to the needs of the benefic association for network marketing to be used as a test bed of the new products, thereby reducing the inventory burden of the business member.

Fourth, the reward sales management unit and the complex mall performance management unit are provide so as to return some of the profits created by the sales of new products sold through the consumer complex mall to the customer, so that general member receives a franchise point saving service and saved points as a reward bonus and the franchise may secure excellent competitiveness differentiated from other competitive road shops.

Fifth, the real-time streaming promotion terminal promoting the products of the customer complex mall in a specific time zone and the community promotion terminal capable of promoting the products in the SNS space of the business member in association with the personal code are provided to easily perform events such as a discount event, a discount coupon, etc. to the final customer and maximize the promotion activity of the business member, thereby easily enlarging the market of the network marketing.

The additional scope of the applicability of the present invention will become apparent from the following detailed description. However, since various modifications and changes within the spirit and scope of the present invention can be clearly understood to those skilled in the art, specific embodiments, such as preferred embodiments of the present invention, should be understood as just as illustrative purposes.

### BRIEF DESCRIPTION OF THE DRAWINGS

FIG. 1 is a diagram for describing a configuration of a marketing system according to the related art,

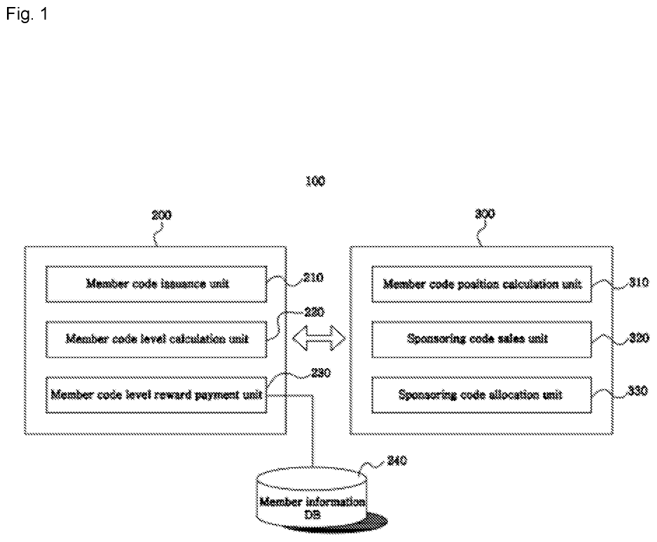

FIG. 2 is a diagram for describing a configuration of a business platform for network marketing of the present invention,

FIG. 3 is a diagram for describing a detailed configuration of the present invention,

FIG. 4 is a diagram for describing a family tree to be applied to the business platform of the present invention,

FIG. 5 is a diagram for describing a compensation system to be applied to the business platform of the present invention, and

FIG. 6 is a diagram for describing a virtuous circulation structure of the business platform of the present invention.

### DETAILED DESCRIPTION

Hereinafter, preferred embodiments of the present invention will be described in more detail with reference to the accompanying drawings.

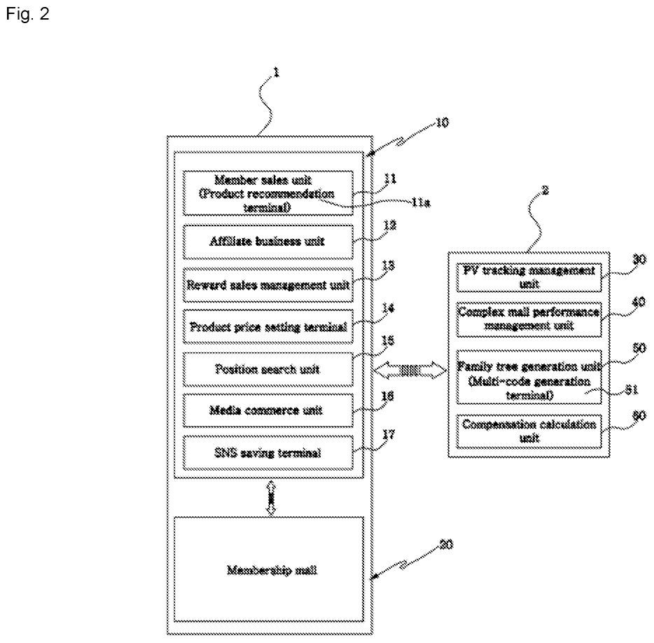

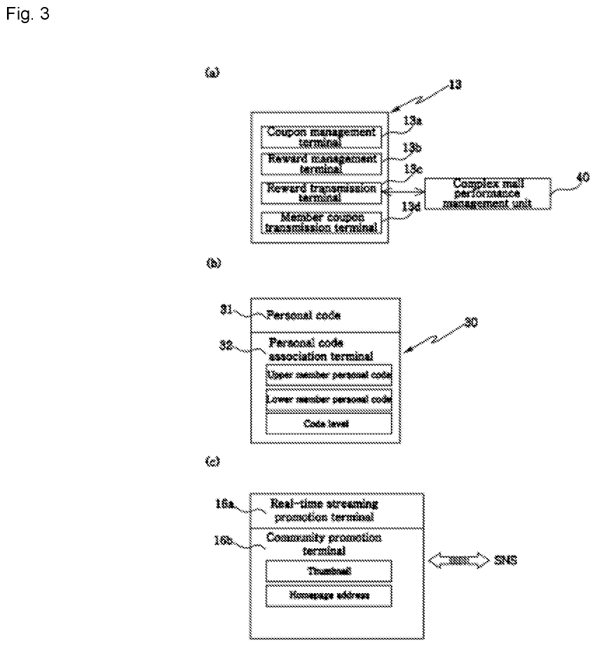

A business platform for network marketing of the present invention, as illustrated in FIGS. 2 and 3, is a business platform for network marketing in which a customer complex mall used by general members as customers to purchase tangible/intangible products and a membership mall used by business members are doubly operated. The business platform for network marketing includes a marketing server 1 constructed with a customer complex mall 10 in which general members as final customers may purchase products and services and a membership mall 20 in which only business members may purchase products; and a point server 2 including a PV tracking management unit 30 which calculates a predetermined point value (PV) in association with a personal code 31 of the business member according to sales generated when the business member purchases or sells the products in the customer complex mall 10 and the membership mall 20.

Here, the personal code 31 is configured by combining an online ID of the business member, division information of the customer complex mall 10 and the membership mall 20, and address information of the product to accurately calculate the sales of the product associated with the business member.

In addition, the PV tracking management unit 30 includes a personal code 31 of an upper member recommending the business member, a personal code 31 of a lower member recommended and registered by the business member, and a personal code association terminal 32 in which a predetermined code level of determining a member rating is stored according to a point value (PV) of the business member, thereby easily generating a family tree to be described below.

Meanwhile, the customer complex mall 10 includes a member sales unit 11 for selling products manufactured or distributed by the business member to general customers; an affiliate business unit 12 for selling products and services of an affiliate for travel goods, car rental goods, airline tickets and offline services; and a reward sales management unit 13 including a coupon management terminal 13a for delivering and managing a discount coupon issued by the affiliate and the business member to general members and a reward management terminal 13b managing a reward according to the products and the services sold to the general member. The customer complex mall 10 handles products and services of an affiliate associated with offline stores such as beauty salon, flower delivery, leports, condo, etc. as well as the products sold by the business member.

At this time, the reward sales management unit 13 includes a reward transmission terminal 13c which transmits a reward for the business member and a sales performance for products in which the business member is registered as a recommender to the point server. The point server 2 includes a complex mall performance management unit 40 which converts and manages the reward and sales performance transmitted from the reward transmission terminal 13c to the point value (PV). Accordingly, the PV of the business member may be saved at a predetermined rate in the sales of the products or the services of the member sales unit 11 and the affiliate business unit 12 to encourage the sales.

The reward management terminal 13b manages a franchise reward provided directly by a franchise opened in the customer complex mall 10, the reward transmission terminal 13c transmits the franchise reward to the complex mall performance management unit 40, and the complex mall performance management unit 40 converts the franchise reward to the point value (PV) to be used for the compensation of the business member.

In addition, even if the general member purchases the product in the customer complex mall 10, the reward management terminal 13b may give a reward benefit such as general point saving to promote the repurchase activity of the general consumer.

Meanwhile, the reward sales management unit 13 includes a member coupon transmission terminal 13d for batch-transmitting the discount coupon to the business member of the membership mall 20 to induce consumption promotion to business members subscribed to the membership mall 20, thereby easily increasing the sales of the franchise of the customer complex mall 10.

In addition, the customer complex mall 10 includes a product price setting terminal 14 for setting the purchase prices of products purchasable by the general member and the business member at a predetermined rate, respectively. At this time, when the purchase price is set so that the business member can buy the product more cheaply to promote the conversion of the general member to the business member.

Further, the customer complex mall 10 includes a position search unit 15 which provides a search service for the position of an offline store so as to search an offline store providing products and services in a mobile phone and purchase the products and the services, thereby promoting the use of offline stores in a local region where business members and general members are located.

Further, the member sales unit 11 includes a product recommendation terminal 11a which transmits a product list which is calculated based on a monthly sales performance of the product so as to register and sell products with the calculated monthly sales performance and excellent preference of the general member in the membership mall 20, so that a product verified by using the customer complex mall 10 as a test bed capable of testing the reliability of a new product may be registered and sold in the membership mall 20.

Meanwhile, the point server 2 includes a family tree generation unit 50 which generates a family tree having a binary structure by grouping a point value (PV) of the business member and point values (PVs) of a plurality of lower business members recommended by the business member into a large performance and a small performance to be divided into left and right sides; and a compensation calculation unit 60 which calculates the code level of the business member based on the large performance and the small performance and calculates a compensation bonus 61 of the business member according to a predetermined compensation rate based on the calculated code level.

Here, the family tree configures lower members recommended by the business member to left and right sides to determine large performance and small performance PVs. At this time, the large performance is related with the rating of the business member and the small performance is used during the calculation of the compensation bonus 61.

In addition, the compensation bonus 61 consists of a weekly pay bonus 62 which is calculated in weekly units, and a monthly pay bonus 63 calculated in monthly units.

The weekly pay bonus 62 includes a recommended bonus 62a which is paid according to a weekly PV calculated depending on weekly new sales and repurchased sales of a lower member recommended by the business member who achieves the code level at a predetermined level or more and a team bonus 62b which is paid at a predetermined rate according to the small performance generated in the family tree, so as to induce activities to encourage lower member recommending activities of the business member and sales activities of lower members.

Meanwhile, the monthly pay bonus 63 includes a leadership bonus 63a which is paid according to a predetermined rate when the business member who achieves the code level at a predetermined level or more achieves the small performance at a monthly PV or more, and a leadership matching bonus 63b which is paid according to a predetermined rate based on the small performance of only the business member who achieves the leadership bonus 63a at a predetermined level or more and the lower member.

Here, the code level represents the rating of the business member and may be divided into ratings of an independent provider, a dealer, a master, a manager, a shop manager, gold, sapphire, ruby, emerald, and diamond according to a cumulative PV of the business member. That is, the higher the rating, the more the compensation bonus 61 that is allocated to the business member.

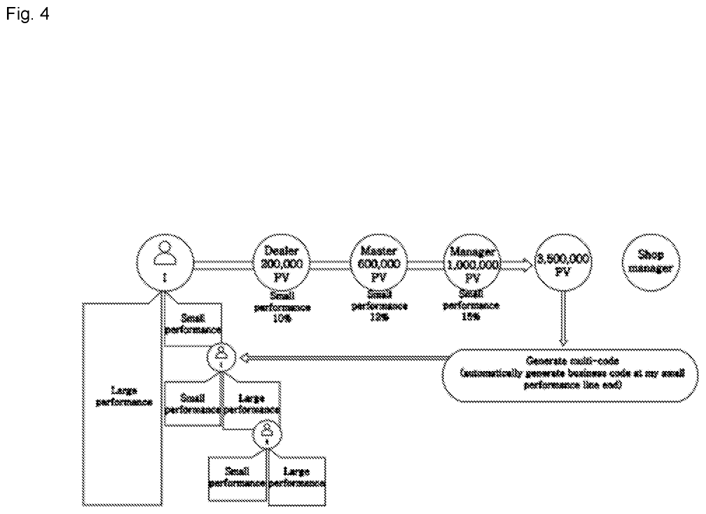

In addition, as illustrated in FIG. 4, the family tree generation unit 50 includes a multi-code generation terminal 51 which generates an avatar code of the business member so that some of the PV of the business member who achieves the code level at a predetermined level or more is included in the bottom of the small performance, thereby obtaining an additional compensation by enlarging the small performance according to self-sales activities of the business member.

Further, the customer complex mall 10 includes a media commerce unit 16 including a real-time streaming promotion terminal 16a which promotes a product provided in real time at a special discount rate in a predetermined time zone as a video and a community promotion terminal 16c which may easily link an event homage address and thumbnails related with the product so as to promote the video of the real-time streaming promotion terminal 16a in conjunction with the personal code 31 in an SNS of the business member in advance; and an SNS saving terminal 17 which saves the sales generated when the general member accesses the SNS of the business member through promotion phrases according to the personal code 31, thereby paying the compensation for the promotion activity of the business member. At this time, it is preferred that the customer complex mall 10 is configured to promote the image of a franchise using letters and emails by analyzing the gender, region, consumption propensity, and hierarchy-specific information of members.

The operation of the business platform for network marketing of the present invention consisting of the above configuration is as follows.

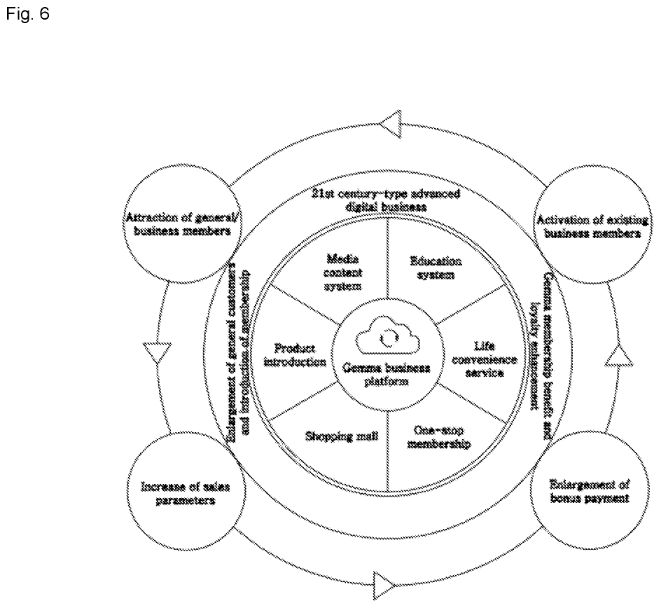

As illustrated in FIGS. 2 to 6, the business platform for network marketing of the present invention provides a business environment useful for both customers and franchises by operating doubly the consumer complex mall 10 used by both general members as customers and business members and the membership mall 20 used by only the business members to allow franchises opened in the consumer complex mall 10 to facilitate increased sales using a human network of business members subscribed in the existing membership mall 20 and provide rewards provided by the franchises and PVs saved according to the rewards to the general members and the business members as compensation.

Then, the consumer complex mall 10 is used as a test bed capable of determining the excellence of the new product, thereby increasing the reliability of the products registered in the membership mall 20. That is, a benefit association of the network marketing sells any product in the customer complex mall 10 for a predetermined period without registering and selling the product directly in the membership mall 20. The product recommendation terminal 11a may transmit a product list with excellent customer response and sales performance to the membership mall 20 and register and distribute the approved product in the membership mall 20.

Accordingly, the product sold in the customer complex mall 10 is operated without any relevance to the benefit association, thereby reducing the inventory burden of the business member.

Meanwhile, the point server 2 includes the PV tracking management unit 30 for managing the sales generated in the customer complex mall 10 in association with the PV of the business member. The PV tracking management unit 30 manages the PV generated by using the personal code 31 of the business member to compensate for a predetermined part for the sales consumed by the business member in the customer complex mall 10 so that the compensation may secure a loyal regular customer at the franchise.

Here, the personal code 31 consists of an online ID of the business member, division information of the customer complex mall 10 and the membership mall 20, and address information of the product to calculate and manage general points provided by the franchise to the PV of the business member by using the division information generated with the sales and the address information of the product.

In addition, the personal code association terminal 32 of the PV tracking management unit 30 manages the personal code 31 of the upper and lower members and the code level in association with the personal code 31 associated with the business member, so that the family tree generation unit 50 may easily generate the family tree of the binary structure divided into the left and right sides.

The family tree generation unit 50 groups the PV of the business member into the large performance and the small performance based on the family tree to be formed in the binary structure divided into the left and right sides. Herein, the large performance is accumulated, so that the rating of business member is calculated based on the large performance, and the compensation bonus 61 is calculated based on the small performance.

Here, the compensation bonus 61 consists of the weekly pay bonus 62 calculated in weekly units and the monthly pay bonus 63 calculated in monthly units. The weekly pay bonus 62 is paid in relation with the performance of a new business member and the monthly pay bonus 63 is paid differentially for each rating depending on the small performance generated according to the family tree.

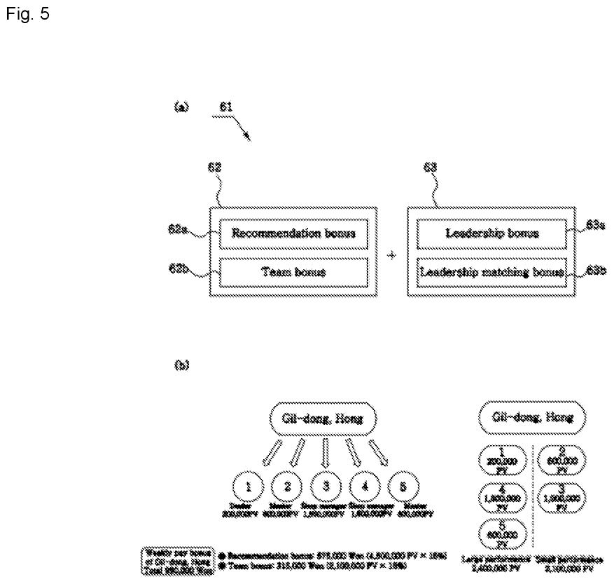

As an example, the recommended bonus 62a of the weekly pay bonus 62, as illustrated in FIG. 5, is summed with the weekly new sales and re-purchase sales PV of the lower member recommended by the business member and 10% of the summed PV is paid. The team bonus 62b of the weekly pay bonus 62 is paid according to each position in a rate of 9%, 10.8%, and 13.5% of the small performance calculated by the family tree.

In addition, the leadership bonus 63a of the monthly pay bonus 63 is paid according to the rate for business members with a code level of gold or more and a monthly small performance of 1 million PV or more. The leadership matching bonus 63b of the monthly pay bonus 63 is paid according to a predetermined rate for each generation based on the small performance of only the business member and the lower members who achieve the leadership bonus 63a to a predetermined level or more. As other bonuses, there are a family bonus that is paid by evaluating a three-month performance, a global bonus according to worldwide sales, etc.

Meanwhile, the reward transmission terminal 13c of the customer complex mall 10 transmits the sales performance purchased or sold by the business member to the point server 2 and the complex mall performance management unit 40 of the point server 2 converts the sales performance to the PV to be used for calculation of the compensation bonus 61. That is, in the customer complex mall 10, the sales performance of the business member is automatically transmitted to the point server 2 to be converted to the PV.

The compensation bonus 61 returns the profit created by the business member to increase the loyalty of business members using the franchise, and the high loyalty of these business members steadily increases new customers to increase the franchise sales beyond expectation.

In addition, the member coupon transmission terminal 13d provided in the reward sales management unit 13 of the customer complex mall 10 may batch-transmit the discount coupon to the business member of the membership mall 20 to easily perform a discount event or a marketing event for the business members.

Further, the product price setting terminal 14 of the customer complex mall 10 differentially exposes a purchase price of a purchasable product of the general member and the business member according to a predetermined rate to induce conversion subscription of the general member to the business member. The conversion of the general member to the business member may increase sales parameters of the franchise and also increase the compensation for the business member with the high loyalty of the franchise, and such a virtuous circulation structure may secure excellent competitiveness that is differentiated from other competitive load shops to the franchise.

Meanwhile, the position search unit 15 of the customer complex mall 10 displays near offline stores on an online map when selecting any product or service to be purchased or used by the member, so that the member may conveniently use the stores as the franchises of the customer complex mall 10.

Further, the media commerce unit 16 and the SNS saving terminal 17 are used to activate the promotion activity of the business member and track the sales generated according to each promotion activity.

That is, the media commerce unit 16 promotes the product as a video through the real-time streaming promotion terminal 16a, the business member may receive and promote the event homepage address and thumbnails related with the product through the community promotion terminal 16c, and the SNS saving terminal 17 may save the sales associated with the personal code 31.

As such, the business platform for network marketing of the present invention provides the customer complex mall 10 capable of increasing the sales parameters and saves and manages the sales of the business member generated in the customer complex mall 10 to the PV to provide a more reasonable compensation system. Furthermore, the business platform for network marketing may easily secure global customers through a human network of overseas business members, so that it is expected to increase sales and aim for overseas expansion.

While the preferred embodiments of the present invention have been illustrated and described above, the present invention is not limited to the aforementioned specific preferred embodiments, various modifications may be made by a person with ordinary skill in the technical field to which the present invention pertains without departing from the subject matters of the present invention that are claimed in the claims, and these modifications are included in the scope of the claims.

What is claimed is:

1. A business platform for network marketing in which a customer complex mall used by general members as customers to purchase tangible/intangible products and a membership mall used by business members are doubly operated, the business platform for network marketing comprising:
a marketing server constructed with a customer complex mall in which general members as final customers are able to purchase products and services and a membership mall in which only business members are able to purchase products; and
a point server including a PV tracking management unit which calculates a predetermined point value (PV) in association with a personal code of the business member according to sales generated when the business member purchases or sells the products in the customer complex mall and the membership mall,
wherein the personal code is configured by combining an online ID of the business member, division information of the customer complex mall and the membership mall, and address information of the product,
the PV tracking management unit includes a personal code of an upper member recommending the business member, a personal code of a lower member recommended and registered by the business member, and a personal code association terminal in which a predetermined code level of determining a member rating is stored according to a point value (PV) of the business member,
the customer complex mall includes a member sales unit for selling products manufactured or distributed by the business member to general customers; an affiliate business unit for selling products and services of an affiliate for travel goods, car rental goods, airline tickets and offline services; and a reward sales management unit including a coupon management terminal for delivering and managing a discount coupon issued by the affiliate and the business member to general members and a reward management terminal managing a reward according to the products and the services sold to the general member,
the reward sales management unit includes a reward transmission terminal which transmits a reward for the business member and a sales performance for products in which the business member is registered as a recommender to the point server,
the point server includes a complex mall performance management unit which converts and manages the reward and sales performance transmitted from the reward transmission terminal to the point value (PV),
the reward management terminal manages a franchise reward provided directly by a franchise opened in the customer complex mall, the reward transmission terminal transmits the franchise reward to the complex mall performance management unit, and the complex mall performance management unit converts the franchise reward to the point value (PV) to be used for the compensation of the business member,
the customer complex mall includes a product price setting terminal for setting the purchase prices of products purchasable by the general member and the business member at a predetermined rate, respectively,
when the purchase price is set so that the business member is able to buy the product more cheaply to promote the conversion of the general member to the business member,
the member sales unit includes a product recommendation terminal which transmits a product list which is calculated based on a monthly sales performance of the product so as to register and sell products with the calculated monthly sales performance and excellent preference of the general member in the membership mall,
the point server includes a family tree generation unit which generates a family tree having a binary structure by grouping a point value (PV) of the business member and point values (PVs) of a plurality of lower business members recommended by the business member into a large performance and a small performance to be divided into left and right sides; and
a compensation calculation unit which calculates the code level of the business member based on the large performance and the small performance and calculates a compensation bonus of the business member according to a predetermined compensation rate based on the calculated code level,
the compensation bonus consists of a weekly pay bonus calculated in weekly units, and a monthly pay bonus calculated in monthly units,
the weekly pay bonus includes a recommended bonus which is paid according to a weekly PV calculated depending on weekly new sales and repurchased sales of a lower member recommended by the business member who achieves the code level at a predetermined level or more and a team bonus which is paid at a predetermined rate according to the small performance generated in the family tree,
the monthly pay bonus includes a leadership bonus which is paid according to a predetermined rate when the business member who achieves the code level at a predetermined level or more achieves the small performance at a monthly PV or more, and a leadership matching bonus which is paid according to a predetermined rate based on the small performance of only the business member who achieves the leadership bonus at a predetermined level or more and the lower member, and
the family tree generation unit includes a multi-code generation terminal which generates an avatar code of the business member so that some of the point value (PV) of the business member who achieves the code level at a predetermined level or more is included in the bottom of the small performance.

2. The business platform for network marketing of claim 1, wherein the reward sales management unit includes a member coupon transmission terminal for batch-transmitting the discount coupon to the business member of the membership mall.

3. The business platform for network marketing of claim 1, wherein the customer complex mall includes a position search unit which provides a search service for the position of an offline store so as to search an offline store providing products and services in a mobile phone and purchase the products and the services.

4. The business platform for network marketing of claim 1, wherein the customer complex mall includes a media commerce unit including a real-time streaming promotion terminal which promotes a product provided in real time at a special discount rate in a predetermined time zone as a video and a community promotion terminal which may easily link an event homage address and thumbnails related with the product so as to promote the video of the real-time streaming promotion terminal in conjunction with the personal code in an SNS of the business member in advance; and an SNS saving terminal which saves the sales generated when the general member accesses the SNS of the business member through promotion phrases according to the personal code.
